(19) United States
(12) Patent Application Publication
(10) Pub. No.: US 2026/0326051 A1
(43) Pub. Date: Oct. 22, 2026

(54) CIRCULENE CRESTED WAVE HOMOGENIZING MIXER

(71) Applicant: HED SYSTEMS, LLC, Charlotte, NC (US)

(72) Inventors: Bruce E. Nadeau, JR., Charlotte, NC (US); Joseph C. Lull, South Haven, MI (US)

(73) Assignee: HED SYSTEMS, LLC, Charlotte, NC (US)

(21) Appl. No.: 19/184,986

(22) Filed: Apr. 21, 2025

(51) Int. Cl. B01F 25/314; B01F 25/10; B01F 25/422; B01F 25/431

(52) U.S. Cl. CPC B01F 25/3141; B01F 25/103; B01F 25/422; B01F 25/43171

(57) ABSTRACT

A mixer device can include: a housing including an interior wall and a longitudinal axis; and a plurality of mixing layers spatially arranged along the longitudinal axis. Each mixing layer of the plurality of mixing layers can include: an injection layer including at least one injector fluidly connectable to a fluid source through the interior wall; and an airfoil layer including a plurality of airfoils extending radially outward from the longitudinal axis toward the interior wall, the airfoil layer positioned rearward of and spaced apart from the injection layer.

### FIELD

The described examples relate generally to mixing fluids.

### BACKGROUND

Fluids of all types are commonly delivered or transported in a variety of ways. Often, fluids are treated at some point in the delivery or transportation process (e.g., to facilitate subsequent refinement processes, storage, use, sale, or production). Treatment can include, for example, chemical treatment to remove, inoculate, dissolve, bind with, sanitize, purify, or alter certain fluid elements or fluid properties. For instance, treatment of water can include “hard” water treatment to remove certain minerals from the water and/or water purification treatment to eliminate at least a threshold amount of viruses and bacteria. As another example, iron distressed oil (e.g., with excess iron content) can undergo iron chelate treatment to reduce iron levels in the crude oil. Additionally or alternatively, dewatering or de-emulsifying solutions can be implemented. These and other conventional treatment processes can be expensive, time consuming, and inefficient. Common iron chelate treatment, for instance, can often entail 10-12 hours of treatment, including agitation steps, decant steps, testing, etc. Therefore, there is an ongoing need for improved systems, apparatuses, and methods of mixing fluids, including in applications for fluid treatment.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to a mixer device. A mixer device can include: a housing including an interior wall and a longitudinal axis; and a plurality of mixing layers spatially arranged along the longitudinal axis. Each mixing layer of the plurality of mixing layers can include: an injection layer including at least one injector fluidly connectable to a fluid source through the interior wall; and an airfoil layer including a plurality of airfoils extending radially outward from the longitudinal axis toward the interior wall, the airfoil layer positioned rearward of and spaced apart from the injection layer.

In some examples, the at least one injector includes a circulene injector. In particular examples, the circulene injector includes a crested wave portion. In one or more examples, the at least one injector includes two or more injectors concentrically arranged within the injection layer. In specific implementations, the plurality of airfoils is oriented to induce fluid rotation about the longitudinal axis. In certain examples, the plurality of mixing layers is configured to induce an alternating direction of fluid rotation about the longitudinal axis. In one example, the interior wall includes one or more flow modifiers. In at least one example, the housing is a single-piece housing.

Another aspect of the present disclosure relates to a mixing device connectable to an open end of a pipe. The mixing device can include: a housing including an interior wall and a longitudinal axis; and a plurality of injectors fluidly connectable to a treatment fluid source through the interior wall, the plurality of injectors being spaced apart relative to each other along the longitudinal axis to achieve a fluid resonance of a fluid flow including one or more fluids and a treatment fluid configured to move through the housing.

In some examples, the mixing device includes a plurality of airfoils positioned between the plurality of injectors, the plurality of airfoils extending radially outward from the longitudinal axis toward the interior wall. In certain examples, the mixing device includes a plurality of airfoils positioned between the plurality of injectors, the plurality of airfoils including a first layer of airfoils and a second layer of airfoils spaced apart and offset from the first layer of airfoils. In specific implementations, each airfoil of the first layer of airfoils is oriented to induce a first rotational direction in the fluid flow; and each airfoil of the second layer of airfoils is oriented to induce a second rotational direction in the fluid flow opposite the first rotational direction. In one or more examples, each injector of the plurality of injectors defines an injector gap between adjacent injectors, a magnitude of the injector gap being tuned to induce the fluid resonance of the fluid flow.

In some examples, each injector of the plurality of injectors is a circulene injector including: a crested wave portion forming a curved surface and a periphery; and a circumferential sidewall defining apertures oriented to flow the treatment fluid out of the circulene injector and at least partially impinge the curved surface or follow along the curved surface toward the periphery. In particular examples, a mixing event is configured to occur when fluid eddies of the treatment fluid form adjacent to the periphery and collide with the one or more fluids moving through the housing. In specific implementations, the housing defines an inner chamber circumferentially defined inside the housing between the interior wall and an exterior wall; and the plurality of injectors is fluidly connectable to the treatment fluid source via the inner chamber.

Yet another aspect of the present disclosure relates to a fluid mixer apparatus. The fluid mixer apparatus can include: a housing defining a fluid flow path configured for passage of a first fluid through the housing along the fluid flow path; a fluid inlet defined on an exterior surface of the housing, the fluid inlet configured to receive a second fluid different from the first fluid; an inner chamber circumferentially defined inside the housing, the inner chamber configured to receive the second fluid from the fluid inlet; a first injection layer including one or more circulene injectors in fluid communication with the inner chamber; a second injection layer separate from the first injection layer, the second injection layer including one or more additional circulene injectors in fluid communication with the inner chamber; a first airfoil layer including a first plurality of airfoils oriented to induce a first direction of fluid flow, the first airfoil layer positioned between the first injection layer and the second injection layer; and a second airfoil layer including a second plurality of airfoils oriented to induce a second direction of fluid flow opposite the first direction of fluid flow, the second airfoil layer positioned fluidly behind the second injection layer.

In some examples, at least one of injector size or a positioning of the second injection layer relative to the first injection layer is tuned to achieve fluid resonance based on fluid attributes of the first fluid and the second fluid. In some examples, one or more components of the fluid mixer apparatus are adjustable to at least one of a different position, a different spacing, or a different orientation within the housing based on fluid attributes of the first fluid and the second fluid. In at least one example, the fluid mixer apparatus includes an external resonance applicator attachable to the housing.

Other technical features may be apparent to one skilled in the art, having the benefit of this disclosure, in connection with the following figures, descriptions, and claims. Further, the subject matter claimed herein is not limited to embodiments that solve any disadvantages or that operate only in environments such as those described above. Rather, this summary section is only provided to illustrate certain feature and embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a schematic environment for a mixer apparatus in accordance with one or more examples of the present disclosure;

FIG. 2 illustrates a schematic view of a mixer device in accordance with one or more examples of the present disclosure;

FIG. 3 illustrates a schematic view of an example configuration of an injection layer in accordance with one or more examples of the present disclosure;

FIG. 4 illustrates a schematic view of another example configuration of an injection layer in accordance with one or more examples of the present disclosure;

FIG. 5 illustrates a schematic view of yet another example configuration of an injection layer in accordance with one or more examples of the present disclosure;

FIG. 6 illustrates a schematic view of a mixer device implementing mixing layers that induce alternating directions of fluid flow rotation in accordance with one or more examples of the present disclosure;

FIG. 7 illustrates a perspective view of a mixer device in accordance with one or more examples of the present disclosure;

FIG. 8 illustrates a front view of the mixer device shown in FIG. 7, according to one or more examples of the present disclosure;

FIG. 9 illustrates a rear view of the mixer device shown in FIG. 7, according to one or more examples of the present disclosure;

FIG. 10 illustrates a cross-sectional view of the mixer device shown in FIG. 7, according to one or more examples of the present disclosure;

FIG. 11 illustrates another cross-sectional view of the mixer device shown in FIG. 7, according to one or more examples of the present disclosure;

FIG. 12 illustrates yet another cross-sectional view of the mixer device shown in FIG. 7, according to one or more examples of the present disclosure;

FIG. 13 illustrates still another cross-sectional view of the mixer device shown in FIG. 7, according to one or more examples of the present disclosure;

FIG. 14 illustrates a longitudinal cross-sectional view of the mixer device shown in FIG. 7, according to one or more examples of the present disclosure;

FIG. 15 illustrates another longitudinal cross-sectional view of the mixer device shown in FIG. 7, according to one or more examples of the present disclosure;

FIG. 16 illustrates a close-up cross-sectional view of an injector of the mixer device shown in FIG. 7, according to one or more examples of the present disclosure;

FIG. 17 illustrates a longitudinal cross-sectional view of a mixer device, according to one or more examples of the present disclosure;

FIG. 18 illustrates a longitudinal cross-sectional view of another mixer device, according to one or more examples of the present disclosure; and

FIG. 19 illustrates a longitudinal cross-sectional view of yet another mixer device, according to one or more examples of the present disclosure.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to mixer devices (e.g., a fluid mixer apparatus, a stationary mixing device for mixing fluids, an in-line fluid mixer, etc.). The mixer devices of the present disclosure are compatible with a variety of fluids, including fluids in various states, to induce mixing of two or more fluids. For instance, a fluid can include a gas, liquid, colloid, suspension, particulate fluid (e.g., with nanoparticles), ferro-fluid, etc. A fluid can also include various fluid properties (e.g., viscosity, temperature) and/or flow conditions, such as Newtonian, laminar, turbulent, or other flow types or conditions. A mixer device as disclosed herein can also be employed for many different flow rates, volume throughput requirements, etc. Similarly, a mixer device can be implemented in a wide variety of applications (e.g., inside a pipe, along a canal, between piping or hose connections, on a portable transportation vehicle or trailer, between reservoirs or tanks, as part of a manufacturing process, etc.). A mixer device of the present disclosure can, thus, be implemented in a wide range of laboratory, industrial, and remote field uses. In specific implementations, a mixer device of the present disclosure can be adapted (e.g., geometries and structures tuned) for a particular fluid to be treated, including oil, gas (e.g., natural gas), water, etc. In at least some examples, a mixer device as disclosed herein can be implemented in a manufacturing process—such as for fluids or compounds in a thixotropic state that are combined with fibrous/filler material in metal casting or thermoplastic forming.

In at least some examples, a mixer device of the present disclosure can improve mixing and/or mixing efficiency relative to conventional mixing devices. For example, a mixer device of the present disclosure can reduce the time and/or fluid flow distance for homogeneous mixing of multiple fluids. As another example, a mixer device of the present disclosure can reduce or eliminate batch times, processing steps, intermediate storage reservoirs, reaction tanks, etc. that are typically implemented with conventional mixing devices and methods. Indeed, in some examples, a mixer device of the present disclosure can lend to improved efficiency of mixing, improved efficiency of space, pipe length, or equipment utilization, and/or improved cost efficiencies. In at least some instances, a mixer device of the present disclosure can be implemented with one or more fluids in-situ, during transport, at extraction, upon delivery, between storage tanks, etc. without conventional intermediate steps to induce mixing of fluids.

In these or other examples, a mixer device of the present disclosure includes a housing arranged with mixing layers. The mixing layers can include a variety of injector configurations sized and shaped to introduce one or more additional fluids (e.g., a treatment fluid) into a fluid flow moving through the housing. The injectors can efficiently disburse the treatment fluid throughout the mixer device, including at different longitudinal and radial locations relative to a longitudinal axis of the mixer device. In some examples, the injectors can include radially arranged injectors, nested injectors, cascading injectors, interleaved or staggered injectors, etc. In particular examples, the injectors can include certain structure (e.g., a crested wave portion) that induces mixing between the injected treatment fluid and the fluid flow. In specific implementations, the injectors can be arranged in combination relative to each other to induce certain fluid attributes (e.g., fluid resonance).

In some examples, a mixing layer of a mixing device can include an airfoil layer (or other layer, such as a blade layer, vane layer, etc.). An airfoil layer can include a set of airfoils to induce additional mixing events (e.g., downstream of an injector). In certain examples, the airfoils of an airfoil layer can enhance turbulence by way of the fluid flow impinging the airfoil surface. Additionally or alternatively, in some examples, the airfoils of an airfoil layer can induce fluid rotation about the longitudinal axis of the mixer device. In at least one example, different airfoil layers can be differently arranged to alternate a direction of fluid rotation about the longitudinal axis (thus further enhancing fluid interactions).

The housing and the airfoils—although positionally fixed or stationary relative to each other and to a pipe (or other mounting application)—include a geometry and structural configuration that can efficiently and effectively induce mixing of fluids. The airfoils, for instance, can impart certain fluid conditions, flow patterns, relative differences in velocity, etc. Various airfoils can be utilized, including helical airfoils, arched (e.g., lenticular) airfoils, curved airfoils, linear airfoils, looped airfoils, or a combination thereof. In some instances, the airfoils can be substantially straight or linear.

Similarly, various housing shapes and sizes can be implemented (e.g., depending on the mounting location and/or space constraints). For example, the housing can be circular, square, triangular, or other polygonal shape (including non-symmetrical shapes). Housing shapes and sizes can also be implemented based on manufacturing considerations, including scalability, configurability, production processes, etc. In particular examples, a housing shape and size can also affect fluid flow attributes (e.g., fluid resonance). Indeed, flow rate, volume, fluid velocities, etc. can all be tuned and scaled to achieve a desired mixing, achieve certain flow characteristics, and/or promote one or more flow paths. Additionally or alternatively, aspects of the fluid can be modified and/or tuned prior to entering the mixer device of the present disclosure—where the adjustable fluid aspects may include fluid viscosity, fluid temperature, or fluid energy—so that the fluid can better achieve a desired mixing, certain flow characteristics, and/or follow one or more flow paths. In some examples, application of an ultrasonic device may provide such a desired tuning.

In more detail, a first fluid (which can include one or more fluids referred to in combination as a “first fluid”) can enter through a main opening of the mixer device. Additionally, the mixer device can receive a second fluid (which can include one or more other fluids, such as a treatment fluid) for injecting into the first fluid. For example, the mixer device can include a fluid inlet (e.g., an inoculant inlet) into the inside of the housing—the fluid inlet being different from and fluidly separate from the main opening of the mixer device. The fluid inlet can be in fluid communication with perforations defined in the injectors to allow the second fluid from inside the housing to exit out of the perforations and into the first fluid as the first fluid flows through the housing.

In one or more examples, a mixer device of the present disclosure can include airfoil surface perturbations. The term “airfoil surface perturbation” can refer to any element or portion of the airfoil surface that can perturb, modify, or enhance fluid flow. In certain examples, an airfoil surface perturbation can magnify fluid flow effects induced by other components, such as fluid flow effects induced by the airfoils themselves, so that interaction of fluids can be improved, increased, or maximized. In one or more examples, an airfoil surface perturbation can conserve fluid momentum and motion of fluids to amplify mixing effects. In some examples, an airfoil surface perturbation can control fluid flow, induce mixing, and/or generate flow patterns (e.g., vortices, flow recursion, etc.) or flow conditions in fluids that flow past an airfoil. In particular examples, an airfoil surface perturbation can include wavelets (e.g., ridges, bumps, protrusions, etc.).

Additionally or alternatively, an airfoil surface perturbation can include serrations (e.g., feathers, fingers, slit portions, helical portions, Archimedean screw portions, etc.). Other airfoil surface perturbations are herein contemplated (e.g., cutaways, scallops, dimples, surface texturing, mesh overlays, flaps, ailerons, spoilers, rudders, kruegers, slats, stabilizers, winglets, trims, etc.). In these or other examples, airfoils surface perturbations can include positionally fixed or static elements. In certain implementations, however, airfoil surface perturbations can include control surfaces, actuatable portions, dynamic (movable) elements, responsive portions, etc. In at least some examples, an airfoil surface perturbation can move, mix, emulsify, or otherwise induce interactions between fluids in such a way that reduces or eliminates clogging, clumping, blocking, choking, building up, or damming of fluid flow—which may be helpful for fluids that are particularly dense, thick, creamy, viscous, dirty, full of particulate, sludge-like, gummy, sticky, gelatinous, pasty, etc. Certain geometries—like a dual-crested helical serration—can provide such enhanced mixing, emulsifying, and/or anti-clogging attributes to a fluid flow.

Other mixing components are contemplated in the present disclosure. For example, a mixer device can include one or more mixing components positioned in between airfoils, suspended between an injection layer and an airfoil layer, and/or along an interior wall surface of the mixer device. In some examples, one or more of such mixing components (e.g., flow modifiers) can include a block, wedge, wall, shelf, protrusion, rib, scallop, etc. positioned on the interior housing surface. In certain examples, the flow modifiers can redirect, funnel, or impose certain fluid flow characteristics. In specific implementations, the flow modifiers can redirect fluid flow into one or more airfoils and/or injectors. In at least one example, the flow modifiers can disrupt boundary layer flow to enhance mixing and prevent stagnation at the interior housing surface.

As mentioned above, a housing for the mixer device can include many different shapes, sizes, configurations, mounting locations, and production process arrangements. In one or more such examples of the present disclosure, a mixing device can optionally include a unified housing (e.g., a single-piece housing) integrally formed as a single unit. In some examples, a unified housing can include a housing that is formed as a unitary body, whole, undivided, seamless, without attachments or add-ons, devoid of component assembly, etc. In some examples, a unified housing can be formed via additive manufacturing, subtractive manufacturing, casting, molding, etc. The terms unified housing and single-piece housing should not be limited, however, to a housing that has only a single piece at the outset of assembly or manufacturing. Indeed, a unified housing or a single-piece housing can include multiple components that are configured/assembled together (whether by interlocking features, fasteners, adhesives, welds, attachment devices like clamps, or combinations thereof). For instance, in some examples, a unified housing can include a split housing with two or more pieces that thread together, bind together, are press-fit, etc. In some examples, a unified housing can include any type of coupling (e.g., slip couplings, threaded couplings, compression couplings), fittings, adapters, reducers, etc.

A unified housing can provide certain example advantages. For instance, a unified housing can simplify and improve manufacturability (and scalability), such as by omitting points of attachment or assembly. Additionally or alternatively, a unified housing can obviate usage of seals (e.g., between pipe walls and a mixer apparatus), which seals can fail due to cracks, excessive fluid pressure, shrinkage and thermal expansion, abrasions, particle contamination, seal interference, etc. In certain examples, a unified housing can lend to improved user adaptation so that a mixer apparatus need not be inserted and fitted into a pipe, hose, or other application. Rather, a unified housing can easily be connectable to an open end of a pipe, a tube, or the like (e.g., via a V-band clamp connection). Additionally or alternatively, a unified housing can connect two discrete segments of a pipe, tube, etc. in a same or similar manner. Like an adapter, the unified housing can be configured to secure (e.g., universally in a plug-and-play fashion) to different mating flanges or couplings of a pre-existing pipe to enable universal or custom fitting of the unified housing. In this way, the unified housing can be fitted to secure into, for example, a plumbing application, a treatment application, or the like—but without needing to retrofit existing infrastructure, tooling, etc.

Those of ordinary skill in the art, having the benefit of this disclosure, will recognize that a unified housing can be implemented with a mixer device in a variety of ways. In some examples, a mixer device with airfoils can be formed integrally with the unified housing (e.g., as a single unit). However, the present disclosure is not so limited. Indeed, a mixer device with injectors or a combination of injectors and airfoils can be fitted inside, slipped inside, fastened to, compression sealed, press fit, or otherwise inserted into the interior of a unified housing at the time of assembly or when applied in the field. The level of manufactured integration of a mixer device with at least one of injectors or airfoils in relation to a unified housing can depend on the desired application, fluid flow, user needs, custom fittings, or combinations thereof.

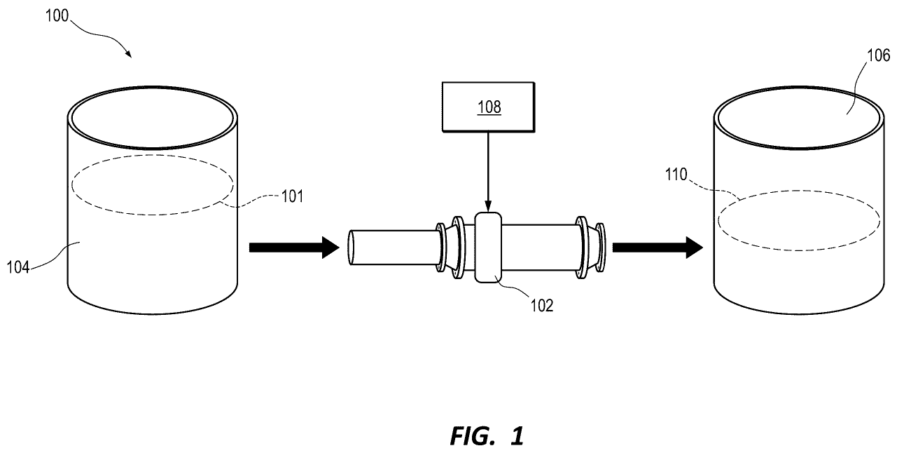

These and other examples are discussed below with reference to FIGS. 1-16. However, a person of ordinary skill in the art—having the benefit of this disclosure—will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an example environment 100 for a mixer apparatus 102 (depicted schematically) in accordance with one or more examples of the present disclosure. In particular, FIG. 1 illustrates a first fluid 101 (e.g., a single fluid or multiple different fluids) associated with a source 104. In particular examples, the first fluid 101 can include a fluid in a first state or condition (e.g., a raw state, a preprocessed state, a pretreated state, an unmixed state, a transport state, a temporary state, etc.). The source 104 can therefore include a reservoir (e.g., a tank, storage container, or fluid body). Additionally or alternatively, the source 104 can include an originating location, a mining location, an extraction site, a drill well, a holding location, a treatment plant, a transportation vehicle, a testing facility, a manufacturing plant, a reservoir of molten metal/thermoplastic material, a laboratory, upstream piping, upstream rivers (or streams, creeks, canals), etc. The source 104 in particular examples is not limited to originating sources (i.e., the furthest upstream source). The source 104 can include any number of downstream sources from an originating source. For example, the source 104 can include a wastewater treatment plant or reservoir (notwithstanding the wastewater may originate from sewer lines or drains leading into the wastewater treatment plant).

The mixer apparatus 102, as will be described in relation to subsequent figures, can mix in a second fluid 108 with the first fluid 101 to produce a mixed fluid 110. In FIG. 1, the mixer apparatus 102 is depicted schematically. In particular, the mixer apparatus 102 can mix in the second fluid 108 with the first fluid 101 as the first fluid 101 flows into (or through) the mixer apparatus 102. That is, the first fluid 101 can flow directionally from the source 104 toward the mixer apparatus 102. In some examples, the first fluid 101 is pumped, forced, or pressured flowed into the mixer apparatus 102. In other examples, the first fluid 101 is gravity fed, naturally flowed, or unaltered in its flow into the mixer apparatus 102.

The second fluid 108 can include one or more fluids that differ from the first fluid 101. In some examples, the second fluid 108 can include an inoculant. In certain implementations, the second fluid 108 can include one or more of acids, asphalten removers, cleaners and degreasers, CO₂ scavengers, corrosion inhibitors, defoamers, dispersants, emulsion breakers, foaming agents, H₂S scavengers, microbicides, oxygen scavengers, paraffin (wax) inhibitors, paraffin solvents, salt inhibitors, scale inhibitors, scale removers, sulfur removers, surfactants, water purifying agents, water clarifiers, etc. In at least some examples, the second fluid 108 can include a fibrous material, a filler material, a viscosity-affecting material, etc.

In turn, the mixed fluid 110 (e.g., a combination, mixture, solution, suspension, cleaned fluid, filtered fluid, treated fluid, etc.) including the first fluid 101 and the second fluid 108 can move from the mixer apparatus 102 to a destination 106. The destination 106 can include any downstream location relative to the mixer apparatus 102. The destination 106 is, therefore, not limited to an end source (i.e., the furthest downstream location or use of the mixed fluid 110). In some examples, the destination 106 can include a fluid body, temporary container, storage tank, reservoir, tanker trailer (or semi-truck trailer), facility, consumer location, municipal piping, industrial end user location, factory, refinery, laboratory, etc.

In these or other examples, the source 104 and the destination 106 can be at different (e.g., remote, off-site) locations. In particular examples, however, the source 104 and the destination 106 can be at a same location (e.g., same facility, same laboratory, same transportation vehicle, etc.), albeit separated at least by the mixer apparatus 102. For example, the mixer apparatus 102 can be implemented in an on-site dosing system in which the first fluid 101 (e.g., distressed oil) is pumped through the mixer apparatus 102 (where mixing occurs with the second fluid 108) to generate the mixed fluid 110 (e.g., iron-treated oil), which is pushed downstream. As another example, the mixer apparatus 102 can be implemented in a mobile dosing system—such as a tanker trailer—in which the first fluid 101 (e.g., distressed oil) is pumped from the source 104 (e.g., a distressed oil tank on the tanker trailer) through the mixer apparatus 102 (where mixing occurs with the second fluid 108) to generate the mixed fluid 110 (e.g., iron chelate treated oil). The mixed fluid 110 can then be pushed downstream to the destination 106 (e.g., a treated oil tank on the same tanker trailer as the distressed oil tank). In yet another example, the destination 106 can include a mold (e.g., a metal casting mold, a thermoplastic mold, etc.)

Regardless of where the source 104 and the destination 106 are, the mixer apparatus 102 can enable in-situ mixing of fluids without requiring separate batch treatments, agitation baths, testing, etc. In omitting these conventional mixing steps, the mixer apparatus 102 can lend to improved system efficiencies by “stacking” (i.e., simultaneously performing) mixing of fluids and en route fluid delivery (e.g., transportation, piping, pumping, storing, etc.).

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 1.

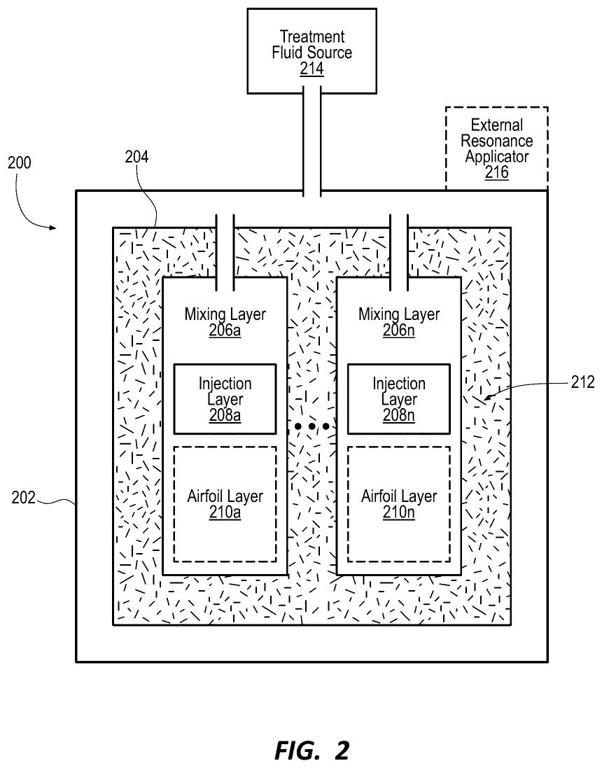

FIG. 2 illustrates a schematic view of a mixer device 200, in accordance with one or more examples of the present disclosure. The mixer device 200 can be the same as or similar to the mixer apparatus 102 discussed above in relation to FIG. 1. As shown, the mixer device 200 can include a variety of elements now discussed.

In some examples, the mixer device 200 can include a housing 202. The housing 202 can include a framework, shell, body structure, or enclosure of the mixer device 200. The housing 202 can include a variety of shapes and sizes (e.g., depending on the application of the mixer device 200). In particular examples, the housing 202 includes an annular ring, cylinder, or torus. In these or other examples, the housing 202 can define a main opening through which fluid (e.g., the first fluid 101 discussed above) can enter and an exit opening through which a combination of fluids (e.g., the mixed fluid 110 discussed above) can exit the mixer device 200. The housing 202, as will be discussed below in relation to certain example embodiments, can include various features such as attachment features (e.g., to attach the housing 202 to a pipe, ground surface, support surface).

Other features of the housing 202 can include, for example, flow modifiers (not shown) that will be discussed below in relation to features that can induce certain flow characteristics and/or mixing events. In particular examples, the housing 202 includes an interior wall 204. The interior wall 204 can include an inside boundary, inner lining, etc. forming the inner surface of the housing 202. In at least one example, the interior wall 204 can correspond to the inner diameter of the housing 202 (e.g., for a circular housing). In certain examples, the interior wall 204 can include one or more flow modifiers (e.g., ribs, protrusions, scallops, serrations, a combination thereof, etc.).

In these or other examples, treatment fluid from a treatment fluid source 214 can be injected into the mixer device 200. A fluid coupling (e.g., a pipe, feeder tube, conduit, etc.) can fluidly connect the treatment fluid source 214 and one or more components positions inside the housing 202 through the interior wall 204. Fluid from the treatment fluid source 214 can be the same as or similar to the second fluid 108 discussed above in relation to FIG. 1. In this way, the treatment fluid source 214 can be used to treat a fluid flow 212 (e.g., that includes one or more other fluids) passing through the housing 202.

To effectively apply the treatment fluid from the treatment fluid source 214 to the fluid flow 212, the mixer device 200 can induce a homogenous mixture (or otherwise thoroughly mix fluids together inside the housing 202). In such examples, the mixer device 200 can create a variety of mixing events via mixing layers 206a-206n (where the term “n” refers to the nth mixing layer). As used herein, a “mixing layer” can refer to an injection layer (alone), or in some cases, a combination of an injection layer and an airfoil layer. In certain examples, a mixing layer includes an injection layer and an airfoil layer positioned adjacent to (e.g., spaced apart and downstream from) the injection layer. In some examples of a mixing layer, an injection layer and an airfoil layer can be sequentially paired together without intervening elements disposed therebetween.

In more detail, the mixing layer 206a can include an injection layer 208a, and the mixing layer 206n can include an injection layer 208n. An injection layer can include one or more injectors that can inject treatment fluid from the treatment fluid source 214 into the fluid flow 212. For example, an injector in an injection layer can define one or more apertures out of which the treatment fluid can flow into contact with the fluid flow 212. The apertures can be arranged in many different ways relative to the structure of the injector and/or relative to the fluid flow 212. In some examples, the apertures can be fluidly connected to inner fluid channels within the injector, which in turn can be fluidly connected to the treatment fluid source 214 through the housing 202.

In certain examples, an injector of the injection layers 208a-208n can induce certain flow characteristics within the mixer device 200. For instance, an injector can induce certain mixing events (e.g., fluid eddies, vortices, turbulence, etc.) between the treatment fluid and the fluid flow 212. These mixing events can be induced from the curvature of the injector, the relative positioning of the injector relative to the interior wall 204, the relative positioning of the injector relative to other injectors in the same mixing layer or another mixing layer, and/or the relative positioning of the injector relative to an airfoil layer. In at least one example, an injector can induce or affect a flow frequency (also referred to herein as a wave frequency, a pulse frequency, or harmonic frequency) of the fluid flow 212. In particular examples, an injector (or a combination of injectors) can help induce fluid resonance of the fluid flow 212. Fluid resonance can occur when the flow frequency of the fluid flow 212 approaches, approximates, or is substantially equivalent to a natural frequency of the fluid flow 212. In some examples, a partial fluid resonance (e.g., a reduced resonance or a muted resonance) can occur when the flow frequency of the fluid flow 212 approximates a fractional multiple above and/or below the natural frequency of the fluid flow 212. At fluid resonance (and at partial fluid resonance), improved mixing of the treatment fluid and the fluid flow 212 can occur. In at least some examples, improved mixing from fluid resonance can occur on a more macro fluid level, such as due to enhanced fluid sloshing, oscillation, turbulence, wave patterns, bulk fluid movement, etc. Additionally or alternatively, improved mixing from fluid resonance can also occur on a micro fluid level (e.g., due to inter-molecular vibrations or oscillations, microscale turbulence, etc.).

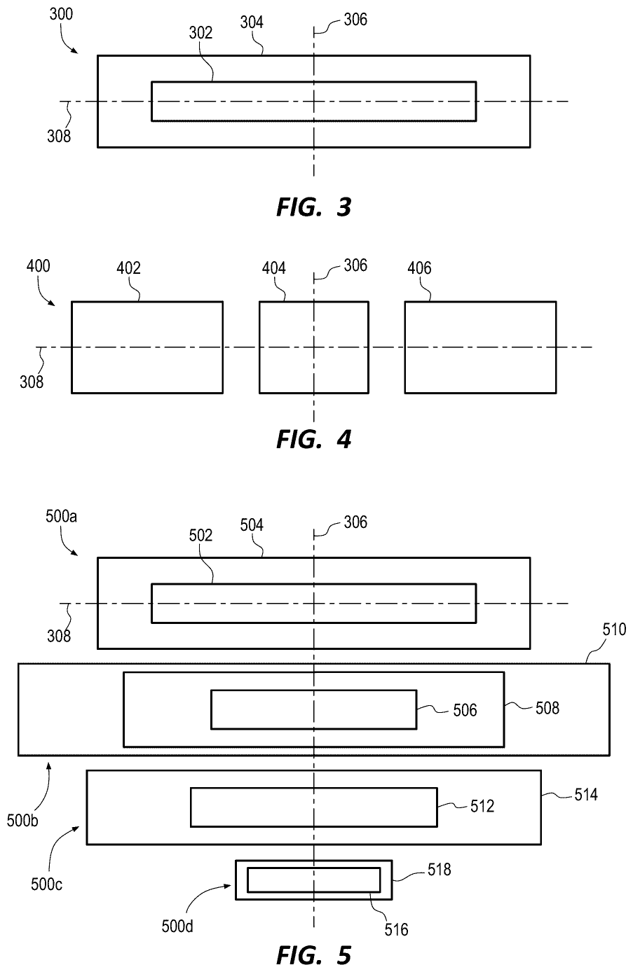

An injection layer can include injectors of myriad different sizes, shapes, and configurations (see, e.g., FIGS. 3-5 and the associated description below). In some examples, an injector of the injection layers 208a-208n is sized and shaped based on the desired throughput of the treatment fluid. In some examples, an injector of the injection layers 208a-208n can be sized and shaped such that, as the fluid flow 212 passes over, around, and/or through various structure of the injector, treatment fluid is drawn out into the fluid flow 212. Additionally or alternatively, an injector can be sized and shaped to induce certain flow characteristics mentioned above. In one or more examples, an injector of the injection layers 208a-208n can correspond to the shape or cross-sectional profile of the housing 202. In at least one example, an injector of the injection layers 208a-208n can include a circulene injector (e.g., a round injector, circle-shaped injector, oval-shaped injector, torus-shaped injector, etc.). In specific implementations, a circulene injector includes a generally circular shape, but with a crested wave portion. The crested wave portion can include an arcuate sidewall of the injector with a portion that protrudes radially outward and overhangs (e.g., extends over or beyond) an adjacent portion of the arcuate sidewall.

Further shown in FIG. 2, the mixer device 200 can optionally include airfoil layers 210a-210n. Each airfoil layer 210a-210n can include a discrete set of airfoils that are positioned in a common plane (e.g., about a central hub). The term “airfoil” can include a shaped member to impart fluid properties and/or leverage fluid mechanics in a fluid system. In some examples, an airfoil includes a shaped member that induces a faster fluid velocity over a first surface and a slower fluid velocity over a second surface. Additionally or alternatively, an airfoil can cause a fluid to move in certain patterns, flow or rotate in certain directions, and/or generate fluid interactions (as will be discussed more below). In some examples, an airfoil can index or position a certain amount of the fluid flow 212 to pass over, around, and/or through certain adjacent structures (e.g., a downstream injector). An airfoil, for example, can separate oncoming fluid into discrete mixing portions that can receive or mix with treatment fluid injected into the fluid flow 212 via the injection layers 208a-208n (as will be described below). In particular, an airfoil can include a leading edge that splits oncoming fluid into a first fluid portion that flows faster across the top surface of the airfoil and a second fluid portion that flows slower across the bottom surface. The leading edge of an airfoil and a trailing edge of an airfoil are contiguous with the major airfoil surfaces (e.g., the top and bottom surfaces of the airfoil).

The airfoils within each of the airfoil layers 210a-210n can have a variety of sizes and shapes. For example, the airfoils can be helical, arched (e.g., in a lenticular housing), curved, linear, looped, or a combination thereof. Airfoil sizes (e.g., airfoil thickness between top and bottom surfaces, airfoil width between a leading edge and trailing edge, or airfoil length between an inboard portion and an outboard portion) can be tuned based on fluid properties, flow rate, volume throughput, desired mixing level (i.e., degree of mixing completeness). Similarly, airfoil pitch (e.g., angle of attack of the leading edge), the direction of pitch (e.g., the directional orientation of the leading edge relative to the trailing edge), and airfoil curvature or geometry can affect desired mixing levels subject to fluid properties, flow rate, volume throughput, etc. A quantity of the airfoils (and/or spacing between each of the airfoils) can also be tuned or optimized for desired mixing levels, fluid properties, flow rate, volume throughput, etc.

In some examples, the airfoils of the airfoil layers 210a-210n can have a variety of configurations. In some examples, the airfoils of the airfoil layers 210a-210n share, at least in part, a common configuration (e.g., an airfoil spacing, number, pitch, size, orientation, position, etc.). In certain examples, the airfoils of the airfoil layer 210a include a different configuration than the airfoils of the airfoil layer 210n. For example, the airfoils of the airfoil layer 210a can be oriented with the leading edge to trailing edge being left to right, and the airfoils of the airfoil layer 210n can be oriented with the leading edge to trailing edge being right to left. As another example, the airfoils of the airfoil layer 210n can be rotationally offset relative to the airfoils of the airfoil layer 210a (e.g., so that adjacent airfoil layers are not stacked or aligned).

In some examples, the airfoils of the airfoil layers 210a-210n can fixedly attach to the housing 202 and a central hub (e.g., a core portion, center mount, middle anchor, main shaft, nose, etc.). That is, the airfoils in some examples are, unlike a turbine or propeller, immovable relative to the housing 202 (and the central hub). The airfoils, in some examples, are thus positionally fixed at both ends. Specifically, the inboard portion (e.g., the innermost end portions of the airfoils) can be fixed to the central hub, and the outboard portion (e.g., the outermost end portions of the airfoils) can be fixed to the housing 202.

In some examples, the airfoils of the airfoil layers 210a-210n can include airfoil surface perturbations. The airfoil surface perturbations can, in particular examples, include wavelets (e.g., ridges, bumps, protrusions, etc.). The airfoil surface perturbations can be rounded or curved in some examples. Additionally or alternatively, the airfoil surface perturbations can include corners, vertices, or edges. In some examples, the airfoil surface perturbations can generate certain flow patterns and/or flow conditions for a fluid passing over and/or around the airfoil surface perturbations. In specific examples, the airfoil surface perturbations can induce flow recursion. In certain examples, airfoil surface perturbations can include serrations (e.g., feathers, fingers, slit portions, etc.) coupled to the trailing edge of the airfoil. In some examples, the serrations can be pitched out of plane relative to the trailing edge (e.g., alternatingly pitched out of plane). In these or other examples, airfoil surface perturbations can help mix in a treatment fluid (or inoculant) with the fluid flow 212.

Further shown in FIG. 2, the mixer device 200 can optionally include an external resonance applicator 216. The external resonance applicator 216 can be attachable (e.g., removably attachable, permanently attachable, etc.) to the housing 202. Additionally or alternatively, the external resonance applicator 216 can be applied upstream to the housing 202 so that the fluid flow 212 proceeding into the housing 202 includes certain flow characteristics, a predetermined viscosity, etc. The external resonance applicator 216 can include one or more elements that can help induce fluid resonance (whether macro and/or micro resonance) of the fluid flow 212 within the housing 202. In some examples, the external resonance applicator 216 can apply energy directly to the housing 202 (thus affecting the fluid flow 212 through the housing 202 but without contacting the fluid flow 212). Additionally or alternatively, the external resonance applicator 216 can apply energy directly to the fluid flow 212 (e.g., via direct contact with the fluid flow 212). Examples of the external resonance applicator 216 can include agitators, stirrers, vibrational elements or vibrators, acoustic transducers or drivers, ultrasonic resonators, fluid phase resonance mixers, etc. The external resonance applicator 216 need not apply energy of motion, however. Indeed, in some examples, the external resonance applicator 216 can include a heating element and/or a cooling element to affect the viscosity of the fluid flow 212, which, in turn, can affect the flow frequency of the fluid flow 212.

In these or other examples, multiple mixer devices 200 can be advantageous for improving mixing of fluids and/or for separately introducing (and mixing in) one or more different treatment fluids. Multiple mixer devices 200 can be spaced apart or joined together, positionally offset (e.g., rotationally twisted relative to one or more other mixer devices 200), and/or arranged with differing structures (e.g., a first mixer device 200 with a first number of mixing layers and a second mixer device with a differing number or differing geometry of mixing layers). Multiple mixer devices 200 can also be advantageous for certain flow rates, volume throughput, and/or types of fluids. For example, multiple mixer devices 200 can be advantageous for higher flow rates and/or larger pipes (larger volume throughput) to help ensure thorough mixing of fluids. To illustrate, a 12-inch inner diameter pipe with water as the fluid may use two mixer devices 200, while a 2-inch inner diameter pipe with crude oil as the fluid may use a single mixer device 200. The number, arrangement, and structural configuration of the mixer devices 200 can thus vary widely based on the fluid and application of choice. In particular examples, the mixer apparatus 102 includes a single mixer device 200. In other examples, the mixer apparatus 102 includes multiple mixer devices 200 (e.g., 2 to 20 mixer devices, 4 to 18 mixer devices, 5 to 15 mixer devices, 7 to 12 mixer devices, or about 10 mixer devices).

Modifications, additions, or omissions to the mixer device 200 are herein contemplated. For example, although not shown, the mixer device 200 can include one or more sensors positioned on or within the housing 202. The one or more sensors can, for instance, measure fluid viscosities, flow rates, flow movement, etc. Additionally or alternatively, the mixer device 200 can include one or more actuators (e.g., electro-mechanical elements, hydraulic actuators, stepper motors, servo motors, geared components, linear graduated solenoids, harmonic drives, etc.) that—when actuated—can cause one or more components of the mixer device 200 to adjust. Component adjustment can include adjustment of at least one of a different position, a different spacing, or a different orientation within the housing 202. Such adjustment can induce a modified flow frequency. To illustrate, one or more injection layers can be adjusted farther apart or moved closer together. Additionally or alternatively, airfoils in the airfoil layers can be adjusted farther away from adjacent injectors or moved closer to adjacent injectors. Airfoils in the airfoil layers may also be actuatable to adjust airfoil pitch, orientation, or intra-layer airfoil spacing. In these or other examples, component adjustment can be based on fluid attributes of at least one of the treatment fluid from the treatment fluid source 214 and/or the fluid flow 212 (e.g., the first and second fluids 101, 108 discussed above in relation to FIG. 1). In certain examples, one or more sensors can detect the fluid attributes in real time, and, in response, the mixer device 200 can adjust one or more components accordingly.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 2.

FIGS. 3-4 illustrate various schematic views of example configurations of an injection layer in accordance with one or more examples of the present disclosure. An injection layer as disclosed herein can include a singular injector independent of any other injectors in the same injection layer. However, injection layers of the present disclosure can include other configurations. These configurations can be suited to the fluid application, fluid flow rate, housing dimensions and shape profiles, etc. In at least one example, different configurations can induce different flow frequencies. For clarity of illustration (particularly for nested embodiments), constituent injectors of an injection layer are schematically portrayed as different-sized boxes. However, those of ordinary skill in the art—having the benefit of this disclosure—will recognize that injectors need not be differently sized.

As shown in FIG. 3, an injection layer 300 (which may be the same as or similar to the injection layers 208a-208n discussed above), can include nested injectors—namely a first injector 302 nested within the perimeter of a second injector 304. Additional nested injectors can also be included. In these or other examples, the first injector 302 and the second injector 304 can be positioned coaxial relative to a longitudinal axis 306 extending longitudinally through the housing (e.g., the housing 202) of the mixer device. As used herein, the term “longitudinal axis” refers to an axis. A longitudinal axis can be a central axis (e.g., for embodiments implementing a symmetrical housing). However, a longitudinal axis need not be positionally centered, particularly for non-symmetrical housings. A longitudinal axis can refer to a reference axis of many possible ray or line positions (e.g., that run in a parallel direction to the main fluid flow path). In some examples, the first injector 302 and the second injector 304 can be concentric relative to each other about the longitudinal axis 306. Additionally, and by residing in the same injection layer 300, the first injector 302 and the second injector 304 can be positioned coplanar to each other along an axis 308 (e.g., a perpendicular axis to the housing 202).

The present disclosure is not limited to nested injectors. FIG. 4 illustrates an injection layer 400 that includes side-by-side, discrete injectors—namely injectors 402, 404, and 406. The injection layer 400 can be the same as or similar to the injection layers 208a-208n discussed above. As depicted, though, only the injector 404 is positioned coaxial to the longitudinal axis 306. The injectors 402, 406 are positioned laterally offset from the longitudinal axis 306. Still, each of the injectors 402, 404, and 406 can be positioned coplanar to each other along the axis 308.

In these or other examples, the injectors 402, 404, and 406 can be structurally equivalent to each other (e.g., same size and shape). In other examples, at least one of the injectors 402, 404, or 406 is structurally different than the other injectors. For example, the injector 404 can include a larger crested wave portion than the injectors 402, 406, more apertures for injecting treatment fluid than the injectors 402, 406, etc.

Any of the features, components, and/or parts, including the arrangements and configurations thereof shown in FIGS. 3-4 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 3-4.

As discussed above, not all injection layers are necessarily the same. A mixer device of the present disclosure can include multiple injection layers that differ from each other. In accordance with one such example, FIG. 5 illustrates injection layers 500a-500d. The injection layers 500a-500d can be the same as or similar to the injection layers 208a-208n discussed above.

In the depicted example of FIG. 5, the injection layers 500a-500d can include interleaved (e.g., staggered, offset, unaligned) injectors positioned along the longitudinal axis 306. In some examples, interleaved injectors can induce improved mixing of the treatment fluid with the fluid flow (e.g., by enhancing fluid resonance and/or by creating more fluid interactions via forced contact with at least one injector). Indeed, in some examples, interleaved injectors can reduce and/or eliminate fluid flow that passes through the mixer device without undergoing a mixing event.

In more detail, the injection layer 500a includes an inner injector 502 nested inside an outer injector 504. Further along the longitudinal axis 306, the injection layer 500b includes three nested injectors—namely an inner injector 506, a middle injector 508, and an outer injector 510. As depicted by the staggered side edges of the injectors, each of the inner injector 506, the middle injector 508, and the outer injector 510 are positionally offset from the inner injector 502 and the outer injector 504 from the adjacent injection layer 500a. Similarly, each of the inner injector 506, the middle injector 508, and the outer injector 510 are positionally offset from an inner injector 512 and an outer injector 514 of another adjacent injection layer 500c. In like manner, an injection layer 500d can include an inner injector 616 and an outer injector 518, both of which can be positioned offset relative to the inner injector 512 and the outer injector 514 of the injection layer 500c.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 5.

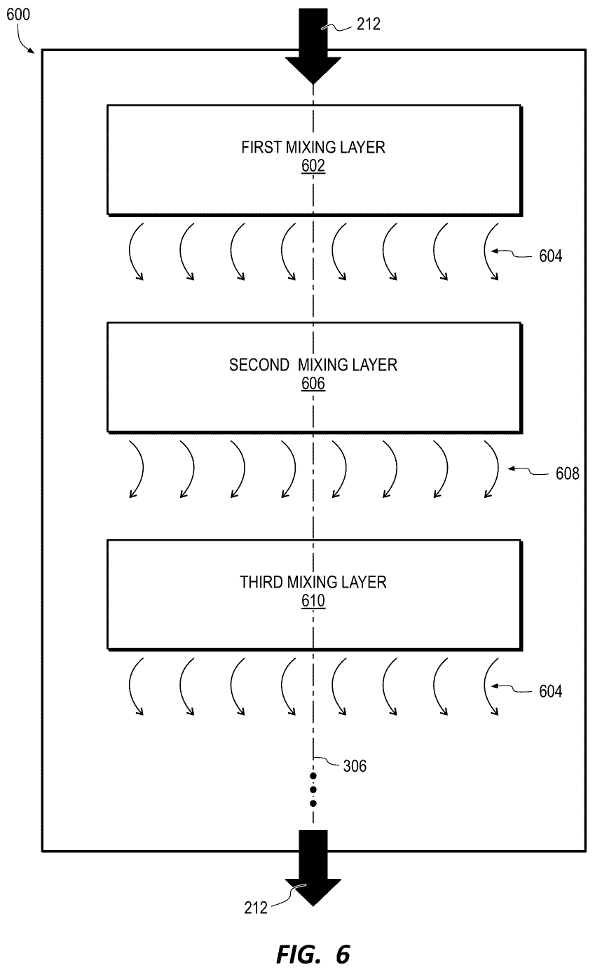

As mentioned above, a mixer device of the present disclosure can include mixing layers that can induce specific flow directions. In some examples, mixing layers can induce an alternating direction of fluid rotation about a longitudinal axis through the mixer device. In accordance with one such example, FIG. 6 illustrates a mixer device 600.

As shown, the mixer device 600 can include a first mixing layer 602, a second mixing layer 606, and a third mixing layer 610 (albeit more layers are herein contemplated, as denoted by the ellipses). As the fluid flow 212 passes through the first mixing layer 602, the first mixing layer 602 can induce a first direction 604 of fluid flow rotation about the longitudinal axis 306. Following the first mixing layer 602 and as the fluid flow 212 proceeds through the second mixing layer 606, the second mixing layer 606 can induce a second direction 608 of fluid flow rotation about the longitudinal axis 306 opposite the first direction 604 of fluid rotation. Subsequent to the second mixing layer 606 and as the fluid flow 212 passes through the third mixing layer 610, the third mixing layer 610 can reverse the rotational flow again by inducing the first direction 604 of fluid flow rotation about the longitudinal axis 306. In this manner, the mixing layers of the mixer device 600 can alternatingly reverse the rotational direction of fluid flow relative to the longitudinal axis 306 as the fluid flow 212 proceeds through the mixer device 600.

In one or more examples, alternating fluid flow rotations can improve mixing of a treatment fluid with the fluid flow 212. For example, alternating fluid flow rotations can inhibit boundary layer formations (e.g., where fluid flow stagnates, such as along the interior housing wall or other component surface). In some examples, alternating fluid flow rotations enhance (e.g., induce more) interactions between treatment fluid and the fluid flow 212. In at least one example, alternating fluid flow rotations increase turbulence, modify fluid resistance, and/or break apart fluid segments-lending to improved mixing or homogenization.

Alternating fluid rotations in the foregoing manner can be achieved in various ways. In particular examples, however (and as will be shown in subsequent figures), alternating fluid flow rotations can be achieved utilizing different pitch orientations of airfoil layers.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 6.

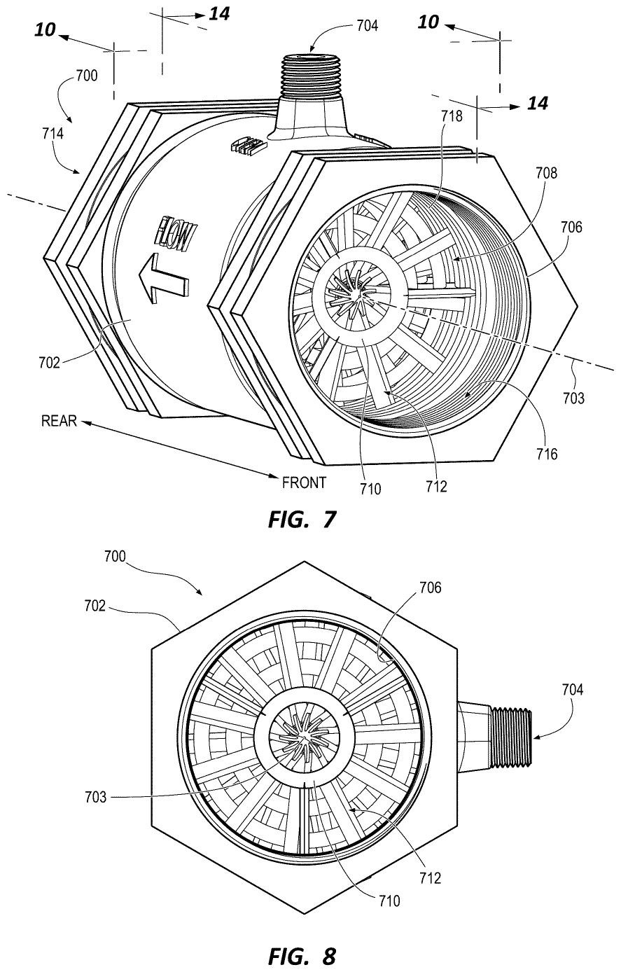

FIGS. 7-9 respectively illustrate a perspective, front, and rear view of a mixer device 700 in accordance with one or more examples of the present disclosure. As shown, the mixer device 700 can include a housing 702 extending along a longitudinal axis 703. The housing 702 can be the same as or similar to the housing 202 discussed above. In particular examples, the housing 702 can include a fluid inlet 704 sized and shaped to receive a treatment fluid (as also discussed above). In some examples, the fluid inlet 704 can include attachment threads to fluidly connect the fluid inlet 704 to a treatment fluid source.

Additionally shown, the housing 702 can define an entry opening 706 and an exit opening 714 opposite the entry opening 706. In these or other examples, a fluid flow to be treated can pass into the housing 702 through the entry opening 706 (e.g., in a direction from front to rear parallel to the longitudinal axis 703).

Once inside the housing 702, a variety of mixing events can occur as the fluid flow engages with a set of mixing layers 708. The mixing layers 708 can be the same as or similar to the mixing layers 206a-206n discussed above. The mixing layers 708 can include many different configurations and arrangements. As shown, however, a first mixing layer of the mixing layers 708 can include an injection layer 710 and an airfoil layer 712 (e.g., which can be the same as or similar to the injection layers 208a-208n and the airfoil layers 210a-210n). In the illustrated example, the injection layer 710 is positioned forward of the airfoil layer 712. The injection layer 710 and the airfoil layer 712 can be paired together and designed, in combination, to induce one or more mixing events and/or certain flow characteristics. For example, the injection layer 710 can include a single injector (in this case, a circulene injector) that can inject treatment fluid from the fluid inlet 704 and into the fluid flow, as will be discussed more below in relation to subsequent figures.

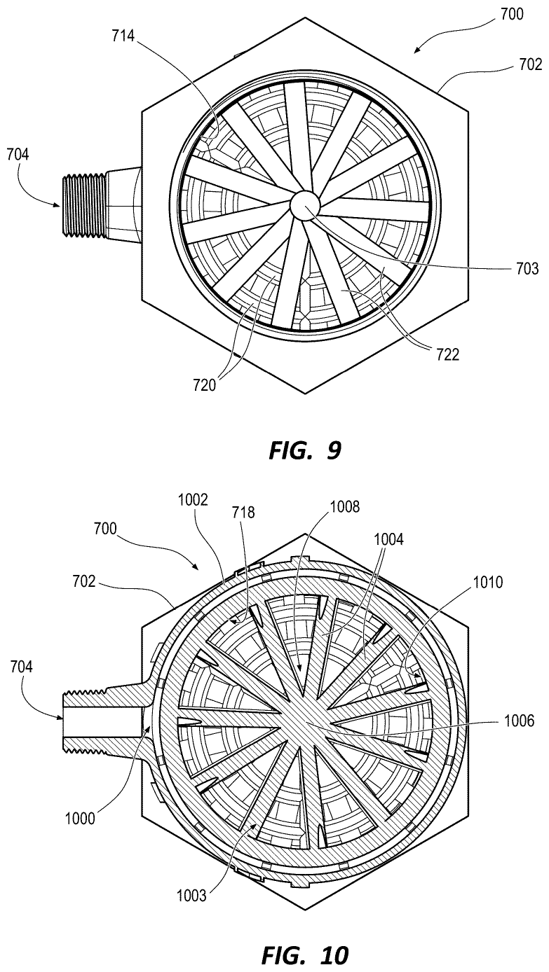

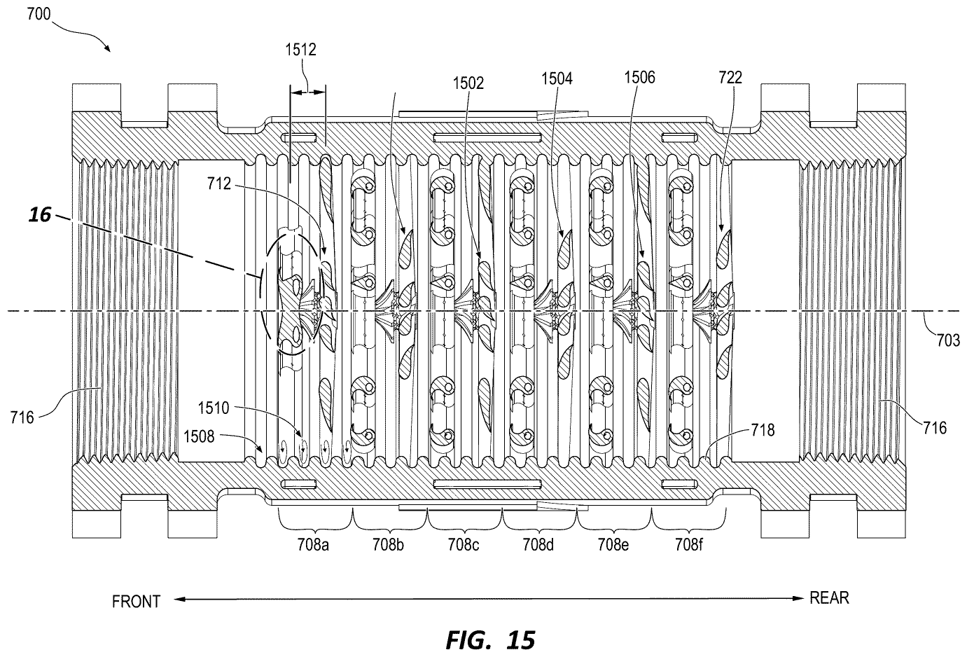

Once injected into the fluid flow, the treatment fluid and the fluid flow can mix together (e.g., adjacent to the crested wave portion of the circulene injector) and then engage with one or more airfoils of the airfoil layer 712. For instance, the fluid flow can impinge the airfoil layer 712 and—by virtue of the airfoil structure, pitch, and orientation—redirect the fluid flow to index either clockwise or counterclockwise (in this case, clockwise) about the longitudinal axis 703. In one or more examples, subsequent mixing layers can then reverse the direction of rotational fluid flow in an alternating fashion to enhance fluid mixing. For example, the mixing layers 708 can include a final mixing layer (shown in FIG. 9) that includes an injection layer 720 and an airfoil layer 722 rearward of the injection layer 720. In some examples, the airfoil layer 722 includes airfoils that are pitched and oriented to index the fluid flow counterclockwise about the longitudinal axis 703 (as will be apparent in FIG. 15) before the fluid flow exits the exit opening 714.

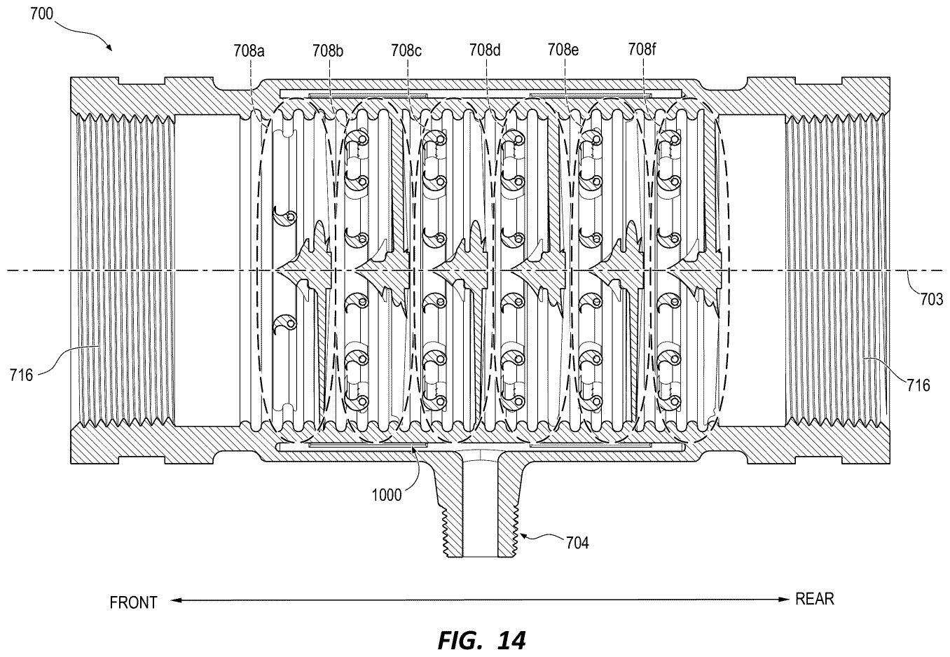

In one or more examples, the housing 702 can define an interior wall 718 (e.g., that corresponds to the inner diameter surface). The interior wall 718 can, in some examples, include a smooth wall surface. In particular examples, and as shown, the interior wall 718 can include flow modifiers that fluidly disrupt the planar continuity and/or surface texture of the interior wall 718. These flow modifiers are discussed more below in relation to subsequent figures (e.g., FIGS. 14-15). In general, however, the flow modifiers defined by the interior wall 718 can help prevent fluid aggregation or stagnation along the outer fluid flow boundary adjacent to the interior wall 718. Indeed, in some examples, the flow modifiers can help enhance mixing by inducing certain mixing events with fluid flow and treatment fluid.

In some examples, the housing 702 can also include attachment threads 716 adjacent to the entry opening 706 and the exit opening 714. The attachment threads 716 can secure the housing 702 to the open ends of a pipe, conduit, fluid channel, etc. In some examples, the attachment threads 716 can be substituted for one or more fittings, attachment features, fasteners, valves, solenoids, flood gates, controllable dams, actuatable dampers, etc.

Any of the features, components, and/or parts, including the arrangements and configurations thereof shown in FIGS. 7-9 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 7-9.

FIGS. 10-13 illustrate perspective cross-sectional views of the mixer device 700 in accordance with one or more examples of the present disclosure. The cross-sectional views are cut progressively rearward beginning from a viewing cut at the fluid inlet 704 in FIG. 10.

As shown in FIG. 10, the housing 702 includes an inner chamber 1000 defined by the interior wall 718 and an exterior wall 1002. The inner chamber 1000 is fluidly connected to the fluid inlet 704 and extends circumferentially around the housing 702. In at least some examples, the inner chamber 1000 is pressurized from the fluid inlet 704 such that the treatment fluid can disburse more evenly throughout the inner chamber 1000 and subsequently into feeder ducts (e.g., feeder ducts 1108 discussed below).

Further shown in FIG. 10, the cut of this cross-sectional view extends through an airfoil layer 1003 that includes airfoils 1004. The airfoils 1004 extend radially outward from a central hub 1006. In these or other examples, an inboard portion 1008 of the airfoils 1004 is coupled to the central hub 1006. In addition, an outboard portion 1010 of the airfoils 1004 is coupled to the interior wall 718.

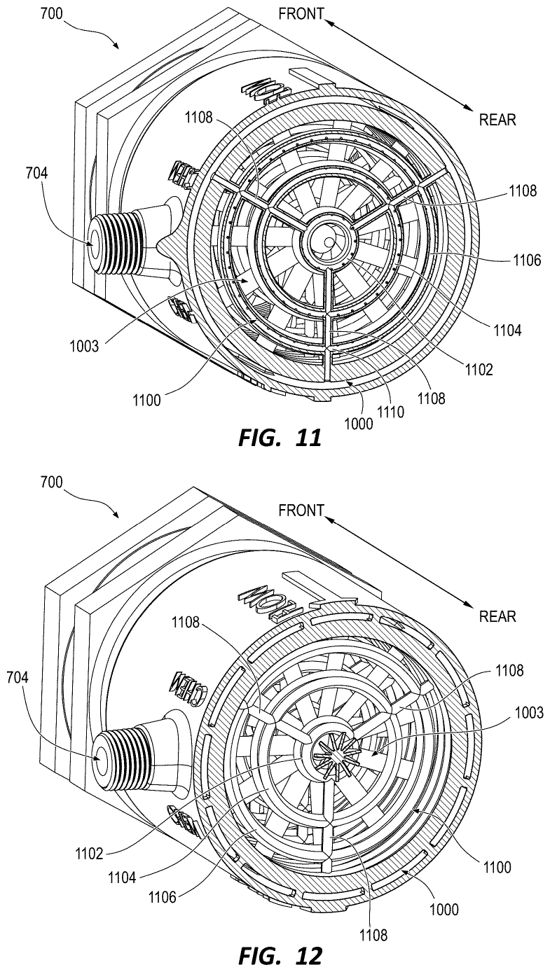

FIG. 11 illustrates a cross-sectional view through an injection layer 1100 (among others in the mixer device 700). The injection layer 1100 can include an injector 1102, an injector 1104, and an injector 1106. More or fewer injectors can be implemented based on desired fluid flow characteristics, fluid attributes of the fluid themselves, etc.

As depicted, the injector 1102 is a central-most injector having a smallest diameter relative to the injectors 1104, 1106. The injector 1104 is positioned adjacent to the injector 1102 and includes a larger diameter than the injector 1102, but a smaller diameter than the injector 1106. The injector 1106 is positioned adjacent to injector 1104 as the outer-most injector and includes the largest diameter relative to the injectors 1102, 1104. As shown, the injectors 1102-1106 share a common plane perpendicular to the longitudinal axis 703 and are concentric relative to each other about the longitudinal axis 703. In addition, the injectors 1102-1106 are spaced apart relative to each other in the common plane. In this way, treatment fluid can be mixed into the fluid flow at varying radial distances from the longitudinal axis 703.

In one or more examples, the injectors 1102-1106 are fluidly connected to the inner chamber 1000 via feeder ducts 1108. The feeder ducts 1108 can include fluid channels 1110 that extend between the inner chamber 1000 and the injectors 1102-1106. The fluid channels 1110, in some examples, continue at least partially into the injectors 1102-1106. In particular examples, the fluid channels 1110 are coextensive with the feeder ducts 1108 and each of the injectors 1102-1106. In some examples, the fluid channels 1110 thus extend along an entirety of the feeder ducts 1108 and the injectors 1102-1106 (e.g., so as to fluidly couple each aperture of the injectors to the inner chamber 1000).

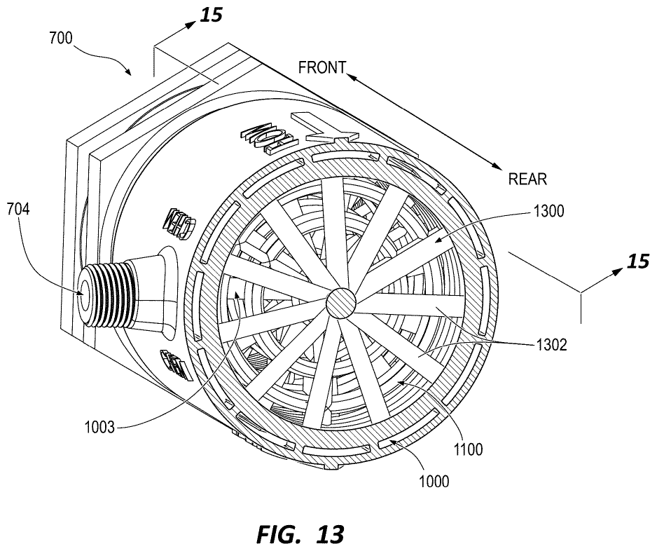

FIG. 12 illustrates yet another cross-sectional view of the mixer device 700. In this cross-sectional view, the cut is further rearward than in FIG. 11 and is positioned between the injection layer 1100 and an airfoil layer (shown subsequently in FIG. 13). This view further depicts an entirety of the injection layer 1100 relative to the airfoil layer 1003 shown in FIG. 10 and positioned forward of the injection layer 1100.

FIG. 13 illustrates still another cross-sectional view of the mixer device 700. In this cross-sectional view, the cut is again positioned rearward relative to the cut of FIG. 12. As shown, the cut of FIG. 13 is positioned rearward of an airfoil layer 1300 that includes airfoils 1302. The airfoils 1302 can be the same as or similar to the airfoils 1004 (albeit a different orientation in some examples). In at least some examples, the airfoil layer 1300 is positionally offset relative to the airfoil layer 1003. In some examples, and as shown more in FIG. 14, each airfoil layer of the mixer device 700 can be alternatingly positioned out-of-phase relative to the adjacent airfoil layer. In some examples, mixing of the fluid flow can be enhanced by misaligning or staggering the airfoil layers in this way.

Any of the features, components, and/or parts, including the arrangements and configurations thereof shown in FIGS. 10-13 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 10-13.

FIGS. 14-15 illustrate longitudinal cross-sectional views of the mixer device 700 in accordance with one or more examples of the present disclosure. The mixer device 700 can include the mixing layers 708 discussed above. As shown, the mixer device 700 can include, for example, mixing layers 708a-708f to induce mixing of a treatment fluid into a fluid flow. Each of the mixing layers 708a-708f can include an injection layer and an airfoil layer. The injection layers can include one or more injectors as discussed above. However, more detail is now provided with respect to the airfoil layers.

The mixing layers 708a-708f can include the airfoil layers 712, an airfoil layer 1500, an airfoil layer 1502, an airfoil layer 1504, an airfoil layer 1506, and the airfoil layer 722, respectively. These airfoil layers can be arranged in various configurations (including at various interspaced distances relative to each other, different positions, and/or at different orientations) based on fluid attributes of at least one of the fluid flow 212 or the treatment fluid. In some examples, the airfoils of the mixing layers 708a-708f can be structurally arranged based on flow characteristics or other constraints affected by the size and/or shape of the mixer device 700 (e.g., to induce fluid resonance). In particular examples, the airfoil layers of the mixing layers 708a-708f can be offset or staggered relative to adjacent airfoil layers to induce more mixing. In some examples, the airfoil layers of the mixing layers 708a-708f are rotationally positioned about the longitudinal axis 703 where the individual airfoils are aligned between adjacent airfoil layers that are fluidly behind and in front of a given airfoil layer. In specific implementations, the airfoil layers of the mixing layers 708a-708f are offset relative to an adjacent airfoil layer by a magnitude ranging between about 5 degrees to about 180 degrees.

In addition, FIGS. 14-15 show that the airfoil layers of the mixing layers 708a-708f can be pitched in alternating orientations to reverse the rotational direction of fluid flow at each subsequent mixing layer. For example, the airfoil layer 712, the airfoil layer 1502, and the airfoil layer 1506 are oriented in one direction (e.g., downstream and clockwise). Conversely, the airfoil layer 1500, the airfoil layer 1504, and the airfoil layer 722 are oriented in another direction (e.g., downstream and counterclockwise). In these or other examples, an alternating configuration of airfoil layers can enhance fluid mixing for improved homogenization.

Further shown, and as mentioned above, the interior wall 718 can include one or more flow modifiers 1508. A flow modifier can include ribs, protrusions, scallops, serrations, a combination thereof, etc. to induce one or more mixing events at or near the interior wall 718. In the illustrated example, the flow modifiers 1508 include a combination of ribs and scallops (or crests and troughs). In some examples, the flow modifiers 1508 can induce boundary eddies 1510 as the fluid flow moves over the protruding rib portion and various fluid portions move radially inward while other portions move radially outward into the scallop portion. The boundary eddies 1510 can include vortices or wave-like fluid breaks that create turbulence and mixing near the interior wall 718. In some examples, the boundary eddies 1510 can redirect fluid flow into at least one of an injector or airfoil of the mixing layers 708a-708f. Additional or alternative geometries of flow modifiers can induce other mixing events and/or compliment desired fluid flow characteristics.

As mentioned above, the injectors of the mixer device 700 can be spatially arranged to induce certain flow attributes (e.g., fluid resonance of the fluid flow). In particular examples, the injectors of the mixing layers 708a-708f can define an injector gap 1512 (e.g., a linear distance separating adjacent injection layers). The injector gap 1512 can be tuned to achieve fluid resonance or other fluid flow characteristic. In some examples, the injector gap 1512 can control the flow frequency by controlling how often (or at what wavelength) the pulses in the fluid flow occur. For example, by increasing the injector gap 1512, the flow frequency can be modified (e.g., decreased by extending the wavelength period). Conversely, by decreasing the injector gap 1512, the flow frequency of the fluid flow can be modified in a different way (e.g., by increasing the flow frequency due to the shortened wavelength period). Thus, in some embodiments, the flow frequency of the fluid flow can be inversely related to the injector gap 1512.

In some examples, the injector gap 1512 can be modified or adjusted in-situ or on-the-fly. For example, one or more of the injectors of the mixing layers 708a-708f can be actuated to move closer together or farther apart. In this way, the mixing layers 708a-708f can adjust in real time based on actual fluid conditions of the fluid flow.

Any of the features, components, and/or parts, including the arrangements and configurations thereof shown in FIGS. 14-15 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 14-15.

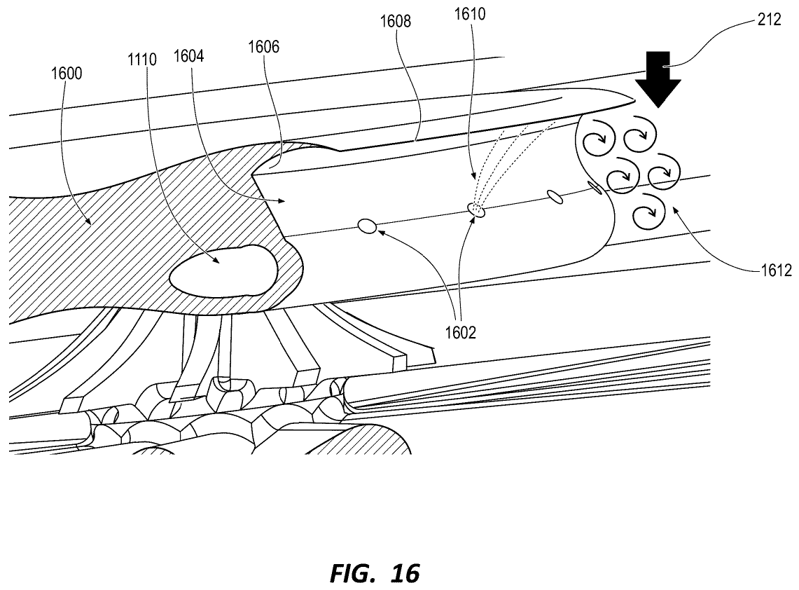

FIG. 16 illustrates a close-up view of an injector 1600 in accordance with one or more examples of the present disclosure. The injector 1600 can be the same as or similar to other injectors described herein. As shown the injector 1600 can define apertures 1602. In some examples, the apertures 1602 are defined around a perimeter of the injector 1600. For example, the apertures 1602 can be circumferentially positioned about the injector 1600.

In at least some examples, the apertures 1602 can be sized, shaped, and/or positioned such that treatment fluid injected from the fluid channels 1110 can engage with the exterior structure of the injector 1600 (e.g., a crested wave portion 1604). To illustrate, treatment fluid can be injected out of the apertures 1602 and can follow one or more treatment fluid injection paths 1610. The treatment fluid injection paths 1610 can, in specific implementations, follow along at least a base of the crested wave portion 1604—namely along a curved surface 1606. In some examples, the treatment fluid injection paths 1610 can proceed along the curved surface 1606 and then curl off at a periphery 1608 of the injector 1600—thereby causing fluid eddies 1612. Additionally or alternatively, the treatment fluid injection paths 1610 can be directed such that treatment fluid can impinge the crested wave portion 1604 at or near the periphery 1608 (e.g., at the overhang portion just inward of the periphery 1608) causing the same or similar fluid eddies 1612. The induced fluid eddies 1612 adjacent to the periphery 1608 can then collide with the fluid flow 212 passing through the mixer device 700—thus lending to rapid and thorough mixing of the treatment fluid.

Any of the features, components, and/or parts, including the arrangements and configurations thereof shown in FIG. 16 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 16.

As mentioned above, a mixer device of the present disclosure can include many different variations, including structural configurations, additions or omissions of certain elements, etc. The following description discusses a few such examples.

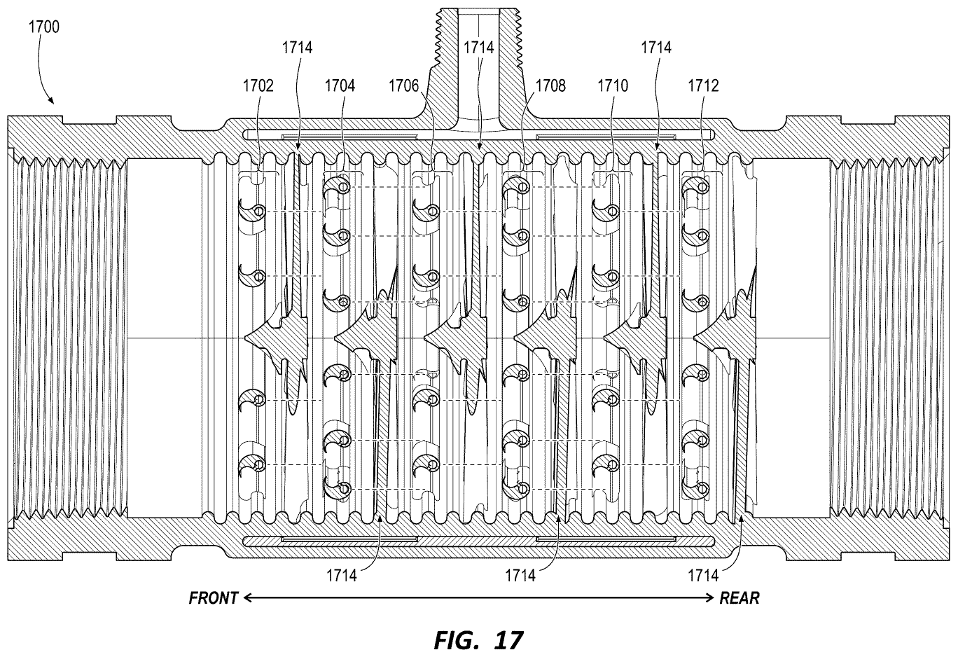

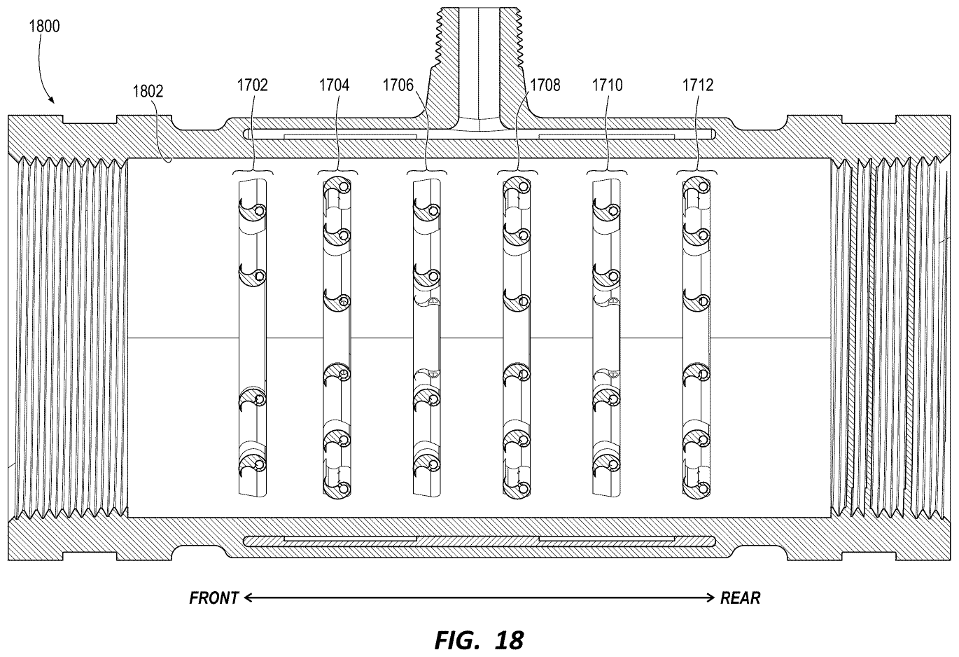

FIG. 17 illustrates a longitudinal cross-sectional view of a mixer device 1700, according to one or more examples of the present disclosure. As shown, the mixer device 1700 includes a combination of injection layers 1702-1712 and airfoil layers 1714 as similarly discussed above in relation to the foregoing figures. In this example, however, the injection layers 1702-1712 are interleaved relative to one another. For instance, the injection layer 1704 includes injectors that are not aligned with the upstream injection layer 1702. That is, the injectors of the injection layer 1702 are positioned longitudinally between the injectors of the injection layer 1704 in a staggered, offset manner. Similarly, the injectors of the injection layer 1704 are positioned longitudinally between the injectors of the injection layer 1706 in a staggered, offset manner. The injectors of the mixer device 1700 can alternate in this fashion. Thus, a fluid flowing through the housing of the mixer device 1700 can, at each injection layer, be indexed toward or away from the interior sidewall when forced to split around the injectors. By being directed into contact with the next downstream injection layer, improved mixing (and, in some cases, improved fluid resonance) can be achieved.

FIG. 18 illustrates a longitudinal cross-sectional view of a mixer device 1800, according to one or more examples of the present disclosure. As shown, the mixer device 1800 includes a combination of injection layers 1702-1712 positioned in an interleaved fashion, as discussed above. However, the mixer device 1800 does not include the airfoil layers 1714 (or any other airfoil layer discussed herein). In this example, the injection layers 1702-1712 are positioned adjacent to each other with no intervening airfoils. In at least some examples, omitting the airfoil layers 1714 can improve or modify fluid resonance for certain fluids, certain flow characteristics (flow rates, volumes, viscosities, etc.), and/or certain size/geometry of housings. For instance, without induced rotation imparted by the airfoil layers 1714, a pulse frequency of the fluid flow can be more easily tuned or achieved for different fluids, more or fewer injection layers may be utilized, and/or other example advantages.

Additionally shown, FIG. 18 depicts an interior wall 1802 without flow modifiers. Indeed, the interior wall 1802 can be smooth or substantially continuous in a manner that is devoid of undulations, surface deviations, or plane breaks. In some examples, a smooth surface for the interior wall 1802 can lend to improved ease of manufacturing relative to interior walls with flow modifiers. In some examples, the interior wall 1802 can be implemented to streamline fluid flow, particularly for accommodating certain housing size/shape constraints.

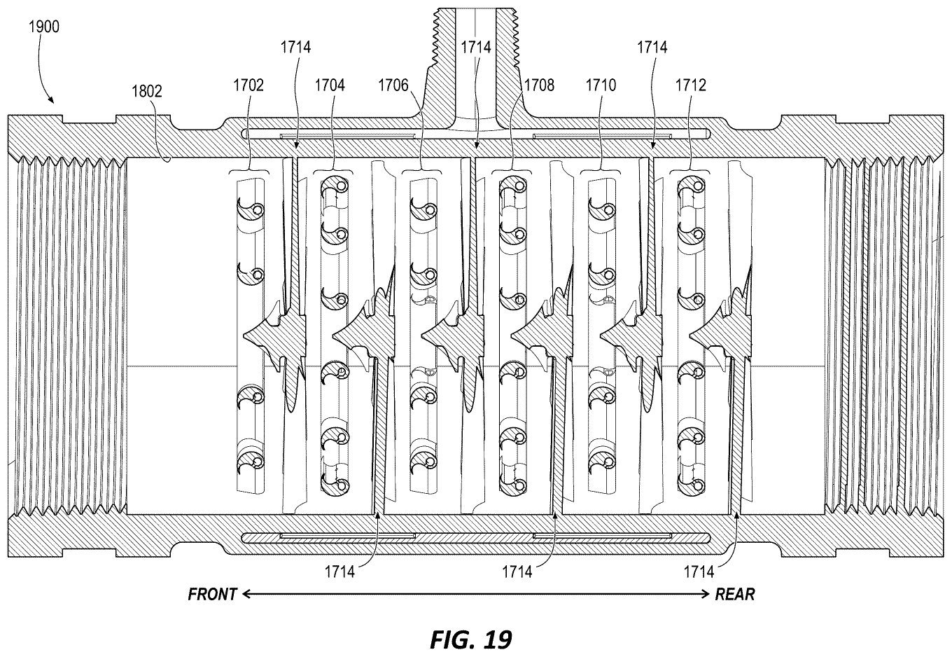

FIG. 19 illustrates a longitudinal cross-sectional view of a mixer device 1900, according to one or more examples of the present disclosure. As shown, the mixer device 1900 is structurally similar to the mixer device 1800. In particular, the mixer device 1900 includes the injection layers 1702-1712 and a smooth surface for the interior wall 1802, each discussed above. In addition, however, the mixer device 1900 includes the airfoil layers 1714 disposed between the injection layers 1702-1712. In some examples, the airfoil layers 1714 can impart fluid rotation (e.g., alternating fluid rotation) and certain flow characteristics that, when combined with the injection layers 1702-1712 and a smooth surface for the interior wall 1802, can be advantageous for mixing certain fluids and/or for mixing under certain housing/size constraints.

Any of the features, components, and/or parts, including the arrangements and configurations thereof shown in FIGS. 17-19 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 17-19.

The foregoing description, for purposes of explanation, used specific nomenclature to provide a thorough understanding of the described examples. However, it will be apparent to one skilled in the art—having the benefit of this disclosure—that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art, having the benefit of this disclosure, that many modifications and variations are possible in view of the above teachings. Indeed, various inventions have been described herein with reference to certain specific aspects and examples. However, many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about,” “approximately,” and “substantially” should be interpreted as +/−10 percent of a stated value.

1. A mixer device, comprising:
a housing comprising an interior wall and a longitudinal axis; and
a plurality of mixing layers spatially arranged along the longitudinal axis, each mixing layer of the plurality of mixing layers comprising:
an injection layer comprising at least one injector fluidly connectable to a fluid source through the interior wall; and
an airfoil layer comprising a plurality of airfoils extending radially outward from the longitudinal axis toward the interior wall, the airfoil layer positioned rearward of and spaced apart from the injection layer.

2. The mixer device of claim 1, wherein the at least one injector comprises a circulene injector.

3. The mixer device of claim 2, wherein the circulene injector comprises a crested wave portion.

4. The mixer device of claim 1, wherein the at least one injector comprises two or more injectors concentrically arranged within the injection layer.

5. The mixer device of claim 1, wherein the plurality of airfoils is oriented to induce fluid rotation about the longitudinal axis.

6. The mixer device of claim 1, wherein the plurality of mixing layers is configured to induce an alternating direction of fluid rotation about the longitudinal axis.

7. The mixer device of claim 1, wherein the interior wall comprises one or more flow modifiers.

8. The mixer device of claim 1, wherein the housing is a single-piece housing.

9. A mixing device connectable to an open end of a pipe, the mixing device comprising:
a housing comprising an interior wall and a longitudinal axis; and
a plurality of injectors fluidly connectable to a treatment fluid source through the interior wall, the plurality of injectors being spaced apart relative to each other along the longitudinal axis to achieve a fluid resonance of a fluid flow comprising one or more fluids and a treatment fluid configured to move through the housing.

10. The mixing device of claim 9, further comprising a plurality of airfoils positioned between the plurality of injectors, the plurality of airfoils extending radially outward from the longitudinal axis toward the interior wall.

11. The mixing device of claim 9, further comprising a plurality of airfoils positioned between the plurality of injectors, the plurality of airfoils comprising a first layer of airfoils and a second layer of airfoils spaced apart and offset from the first layer of airfoils.

12. The mixing device of claim 11, wherein:
each airfoil of the first layer of airfoils is oriented to induce a first rotational direction in the fluid flow; and
each airfoil of the second layer of airfoils is oriented to induce a second rotational direction in the fluid flow opposite the first rotational direction.

13. The mixing device of claim 9, wherein each injector of the plurality of injectors defines an injector gap between adjacent injectors, a magnitude of the injector gap being tuned to induce the fluid resonance of the fluid flow.

14. The mixing device of claim 9, wherein each injector of the plurality of injectors is a circulene injector comprising:
a crested wave portion forming a curved surface and a periphery; and
a circumferential sidewall defining apertures oriented to flow the treatment fluid out of the circulene injector and at least partially impinge the curved surface or follow along the curved surface toward the periphery.

15. The mixing device of claim 14, wherein a mixing event is configured to occur when fluid eddies of the treatment fluid form adjacent to the periphery and collide with the one or more fluids moving through the housing.

16. The mixing device of claim 9, wherein:
the housing defines an inner chamber circumferentially defined inside the housing between the interior wall and an exterior wall; and
the plurality of injectors is fluidly connectable to the treatment fluid source via the inner chamber.

17. A fluid mixer apparatus, comprising:
a housing defining a fluid flow path configured for passage of a first fluid through the housing along the fluid flow path;
a fluid inlet defined on an exterior surface of the housing, the fluid inlet configured to receive a second fluid different from the first fluid;
an inner chamber circumferentially defined inside the housing, the inner chamber configured to receive the second fluid from the fluid inlet;
a first injection layer comprising one or more circulene injectors in fluid communication with the inner chamber;
a second injection layer separate from the first injection layer, the second injection layer comprising one or more additional circulene injectors in fluid communication with the inner chamber;
a first airfoil layer comprising a first plurality of airfoils oriented to induce a first direction of fluid flow, the first airfoil layer positioned between the first injection layer and the second injection layer; and
a second airfoil layer comprising a second plurality of airfoils oriented to induce a second direction of fluid flow opposite the first direction of fluid flow, the second airfoil layer positioned fluidly behind the second injection layer.

18. The fluid mixer apparatus of claim 17, wherein at least one of injector size or a positioning of the second injection layer relative to the first injection layer is tuned to achieve fluid resonance based on fluid attributes of the first fluid and the second fluid.

19. The fluid mixer apparatus of claim 17, wherein one or more components of the fluid mixer apparatus are adjustable to at least one of a different position, a different spacing, or a different orientation within the housing based on fluid attributes of the first fluid and the second fluid.

20. The fluid mixer apparatus of claim 17, further comprising an external resonance applicator attachable to the housing.

21. A method of mixing fluids, the method comprising:
extracting a source fluid from an extraction site;
flowing the source fluid toward a mixer device;
injecting a treatment fluid into the source fluid;
mixing, within the mixer device, the treatment fluid and the source fluid; and
flowing out of the mixer device a combination of the treatment fluid and the source fluid.

22. The method of claim 21, wherein the source fluid comprises at least one of oil or natural gas.

23. The method of claim 21, wherein the extraction site comprises at least one of a drill well or a mining location.

24. The method of claim 21, further comprising storing the source fluid in a storage reservoir while the source fluid is in a first state.

25. The method of claim 24, wherein the first state comprises at least one of a raw state, a preprocessed state, a pretreated state, an unmixed state, a transport state, or a temporary state.

26. The method of claim 21, wherein the treatment fluid comprises at least one of a paraffin inhibitor or a paraffin solvent.
